(19) United States
(12) Patent Application Publication
(10) Pub. No.: US 2007/0246537 A1
(43) Pub. Date: Oct. 25, 2007

(54) SCANNERS, SCAN MODULES AND SCANNING METHODS THEREOF

(76) Inventors: Jun Chen, Jiangsu (CN); Da-Wei Huang, Jiangsu (CN); Ming-Kuan Qian, Jiangsu (CN)

Correspondence Address: QUINTERO LAW OFFICE, PC, 2210 MAIN STREET, SUITE 200, SANTA MONICA, CA, 90405, US

(21) Appl. No.: 11/696,087

(22) Filed: Apr. 3, 2007

(30) Foreign Application Priority Data
Apr. 4, 2006 (TW) 95111949

(51) Int. Cl. G06K 7/10

(52) U.S. Cl. 235/454

(57) ABSTRACT

Scan modules are provided. A scan module includes a carrier, a first lens fixed to the carrier, a second lens movably connected to the carrier, and an optical sensor fixed to the carrier. The first lens detects light from a scan area through the first lens to the optical sensor along an optical path when the second lens is in a first position and out of the optical path. The second lens intervenes and alters the optical path when in a second position.

### BACKGROUND OF THE INVENTION

1. Field of the Invention

The invention relates in general to scanners and in particular to scanners capable of different resolutions.

2. Description of the Related Art

Generally, scan scope of a conventional scanner corresponds to the dimensions of frequently scanned documents. When scan scope and optical focal length are determined, resolution of the scanner is fixed. As conventional scanners usually scan documents of regular sizes, they may perform poor pixel utilization and inadequate resolution when scanning small size documents, such as positive or negative films.

Referring to FIG. 1, a conventional CCD scanner 10 includes a lens 1 and a CCD 2, wherein optical magnification of the scanner 10 is fixed. When scanning a small document 3, only a small region of the CCD 2 is occupied (even less than ¼ of the CCD 2) by the projected image of the document 3, as shown in FIG. 1, thus leading to poor resolution and inefficient pixel utilization of the CCD 2.

While redesigning the lens and the CCD is a conventional solution to improve resolution when scanning small documents, it inevitably increases production cost and may be unnecessary for scanning documents of regular sizes.

### BRIEF SUMMARY OF THE INVENTION

Scan modules are provided. A scan module includes a carrier, a first lens fixed to the carrier, a second lens movably connected to the carrier, and an optical sensor fixed to the carrier. The first lens detects light from a scan area through the first lens to the optical sensor along an optical path when the second lens is in a first position and out of the optical path. The second lens intervenes and alters the optical path when in a second position.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional CCD scanner when scanning a small document;

FIGS. 2a and 2b are perspective diagrams of optical paths of a scan module of this invention;

FIG. 3 is a perspective diagram of a scanner;

FIG. 4a is a perspective diagram of a scan module;

FIG. 4b is a perspective diagram of the scan module in FIG. 4a with a cover removed;

FIG. 4c is an enlarged view of portion A in FIG. 4b;

FIG. 4d is a perspective diagram of a second lens;

FIG. 5a is a perspective diagram of optical paths of a scan module when a second lens is in a first position;

FIG. 5b is a perspective diagram of optical paths of a scan module when a second lens is in a second position;

FIGS. 6a and 6b are perspective diagrams of a scan module utilizing an embodiment of a driving mechanism;

FIGS. 7a and 7b are perspective diagrams of a scan module utilizing another embodiment of a driving mechanism;

FIGS. 8a and 8b are perspective diagrams of a scan module utilizing another embodiment of a driving mechanism;

FIG. 8c is a perspective diagram of a linkage structure;

FIG. 9a is a side view of a scan module when, a linkage structure is in a first state;

FIG. 9b is a side view of a scan module when a linkage structure is in a second state; and

FIG. 9c is a top view of the linkage structure in FIG. 9b.

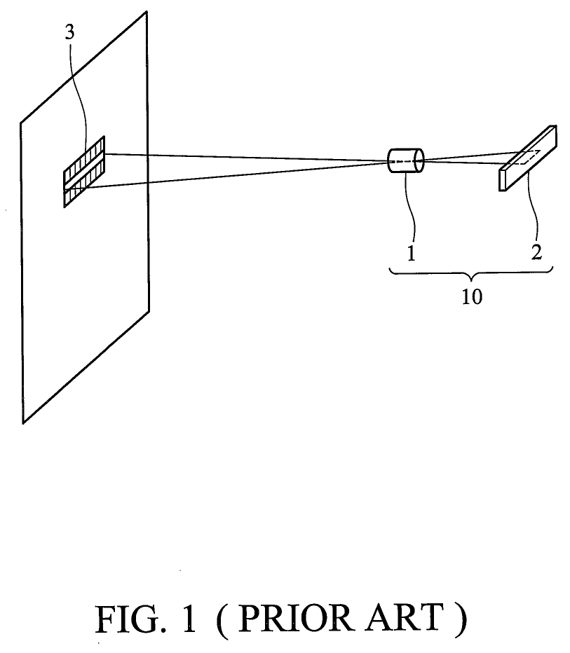

### DETAILED DESCRIPTION OF THE INVENTION

The invention provides a scan module including a primary lens and a movable auxiliary lens for scanning regular documents or small documents. When scanning regular documents, the primary lens is applied. When scanning small documents, the auxiliary lens is optically incorporated with the primary lens to achieve higher scan resolution.

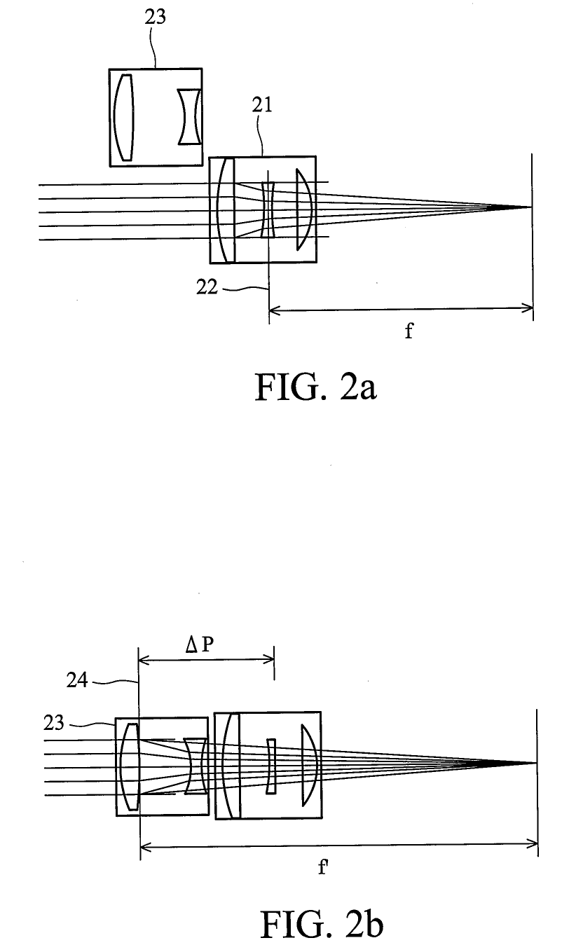

Referring to FIGS. 2a and 2b, an embodiment of a scan module includes a primary lens 21 and a movable auxiliary lens 23. When scanning a regular document, as shown in FIG. 2a, the scan module is in a first mode, wherein an optical principal surface 22 of the primary lens 21 defines a first focal length f. When scanning a small document, as shown in FIG. 2b, the scan module is in a second mode, wherein the auxiliary lens 23 is aligned and optically incorporated with the primary lens 21, such that widths of conjugate scanning rays are narrowed to facilitate higher optical magnification. In FIG. 2b, a second focal length f′ longer than the first focal length f is defined by a new optical principal surface 24, wherein displacement between the optical principal surfaces 22 and 24 is ΔP=(f′−f). The scan module can be switched between the first and second modes to scan regular documents or small documents by arrangement of the primary lens 21 and the movable auxiliary lens 23.

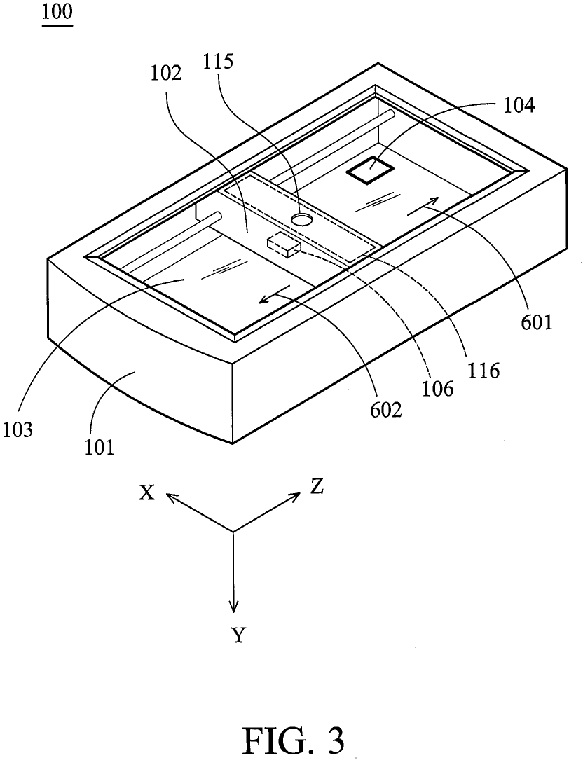

Referring to FIG. 3, an embodiment of a scanner 100 comprises a housing 101 and a scan module 102. The housing 101 has a transparent plate 103 with an object 104 disposed thereon. The scan module 102 is disposed in the housing 101 and movable along Z axis, as the arrows 601 and 602 indicate in FIG. 3.

As shown in FIG. 3, the scan module 102 comprises an optical sensor 106 defining a scan area 116. In this embodiment, the scan area 116 is substantially above the transparent plate 103. When scanning the object 104, the scan module 102 moves along the direction 601, such that the object 104 is located within the scan area 116 to be scanned clearly.

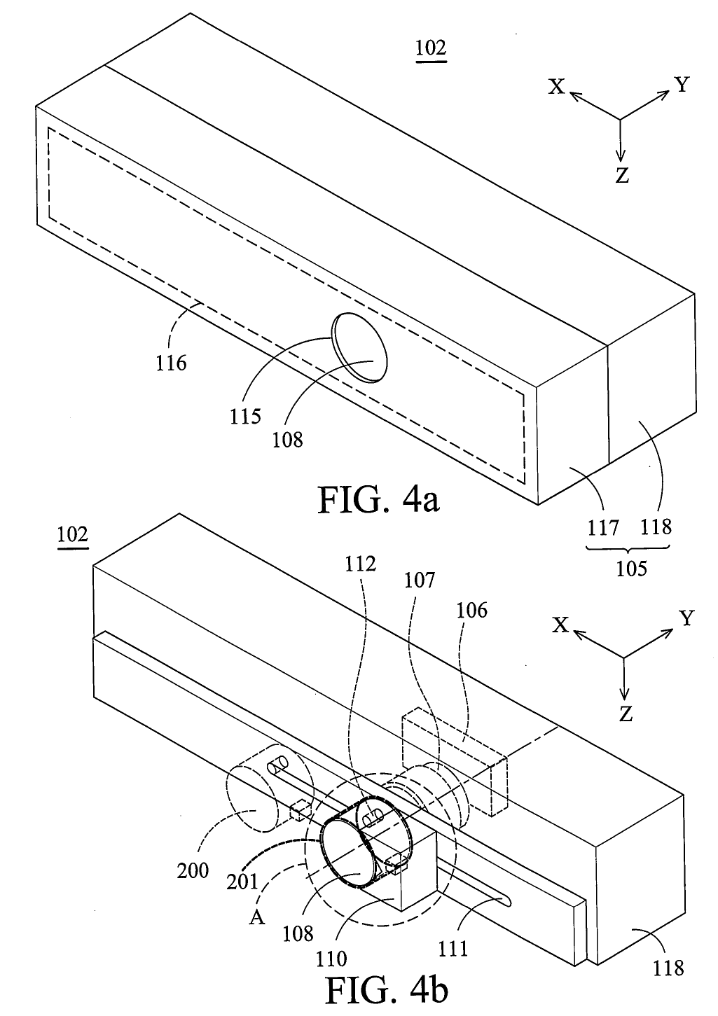

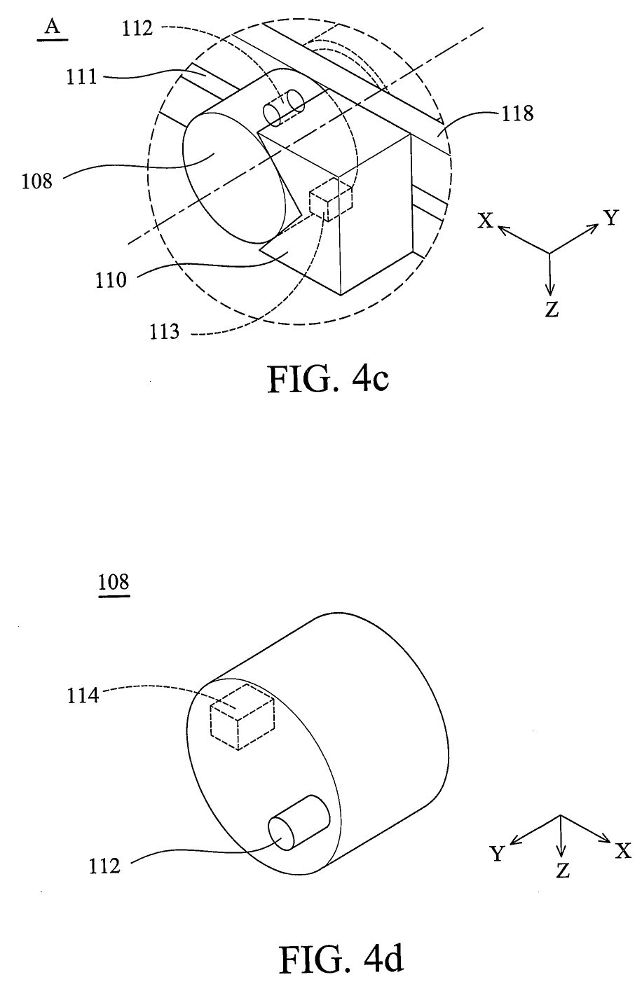

Referring to FIGS. 4a and 4b, the scan module 102 primarily includes a carrier 105, an optical sensor 106, a first lens 107, a movable second lens 108, a positioning block 110 and a driving mechanism (not shown) for impelling the second lens 108. As shown in FIG. 4a, the carrier 105 comprises a cover 117 and a main body 118. The optical sensor 106, such as a CCD, is disposed in the main body 118 of the carrier 105. The first lens 107 is fixed to the main body 118 and located between the scan area 116 and the optical sensor 106.

As shown in FIG. 4b, the second lens 108 is connected to the main body 118 and movable between a first position 200 and a second position 201. In this embodiment, the main body 118 has a rail 111, and the second lens 108 has a slider 112 sliding along the rail 111.

Referring to FIGS. 4c and 4d, the positioning block 110 fixed to the main body 118 has a recess 113, and correspondingly, the second lens 108 has a nub 114 joined in the recess 113 when the second lens 108 moves to the second position 201, as shown in FIG. 4c, such that the second lens 108 is held in the second position 201. Furthermore, the driving mechanism (not shown) is disposed in the main body 118 to impel the second lens 108 between the first and second positions 200 and 201.

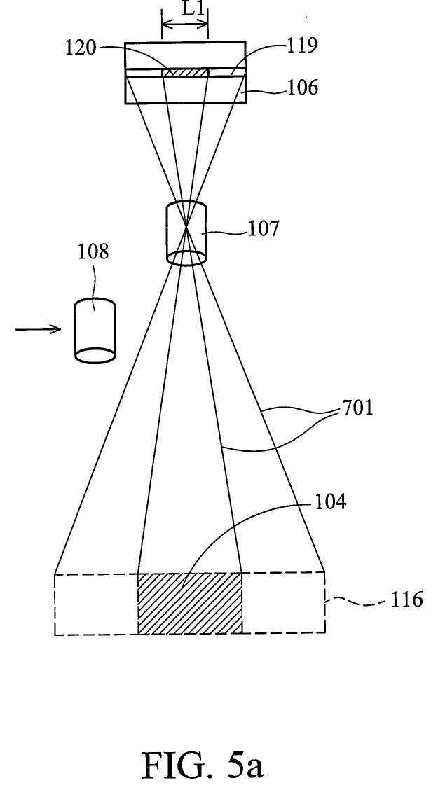

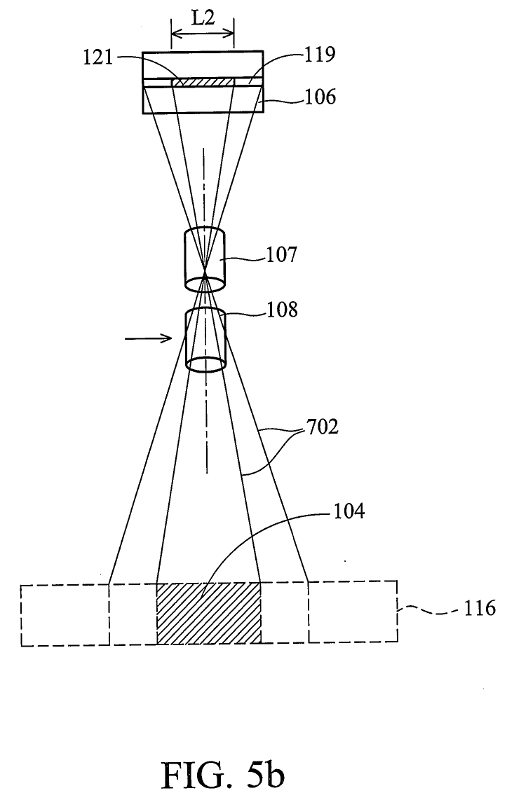

FIG. 5a depicts optical paths 701 when the second lens 108 is in the first position 200 for scanning the object 104. As shown in FIG. 5a, when scanning the object 104, the first lens 107 and the optical sensor 106 of the scan module 102 are aligned with the object 104, such that the object 104 is located within the scan area 116. Hence, the optical sensor 106 detects light from the scan area 116 through the first lens 107 along the light paths 701, and a first image 120 is formed on a sensitive area 119 of the optical sensor 106, corresponding to the object 104 within the scan area 116. Specifically, the second lens 108 is out of the light paths 701, that is, light paths 701 from the scan area 116 to the optical sensor 106 are independent from the second lens 108.

FIG. 5b depicts new optical paths 702 when the second lens 108 moves to the second position 201 for scanning the object 104. As shown in FIG. 5b, when the second lens 108 moves to the second position 201 in front of the first lens 107, the first and second lenses 108 are centrally aligned and optically incorporated with each other, to produce new optical paths 702, different from the first optical paths 701 shown in FIG. 5a. Here, the optical sensor 106 detects light from the scan area 116 through the first and second lenses 107 and 108 along the light paths 702, such that a second image 121 is formed on the sensitive area 119 of the optical sensor 106, corresponding to the object 104 within the scan area 116.

Comparing FIG. 5b with FIG. 5a, the width L2 of the second image 121 exceeds the width L1 of the first image 120. Namely, dimensions of the optical sensor 106 occupied by the second image 121 exceed those of the first image 120, increasing the pixel utilization of the optical sensor 106, such that the optical magnification increased and the resolution improved.

Embodiments of the driving mechanism for moving the second lens 108 between the first and second positions 200 and 201 are disclosed.

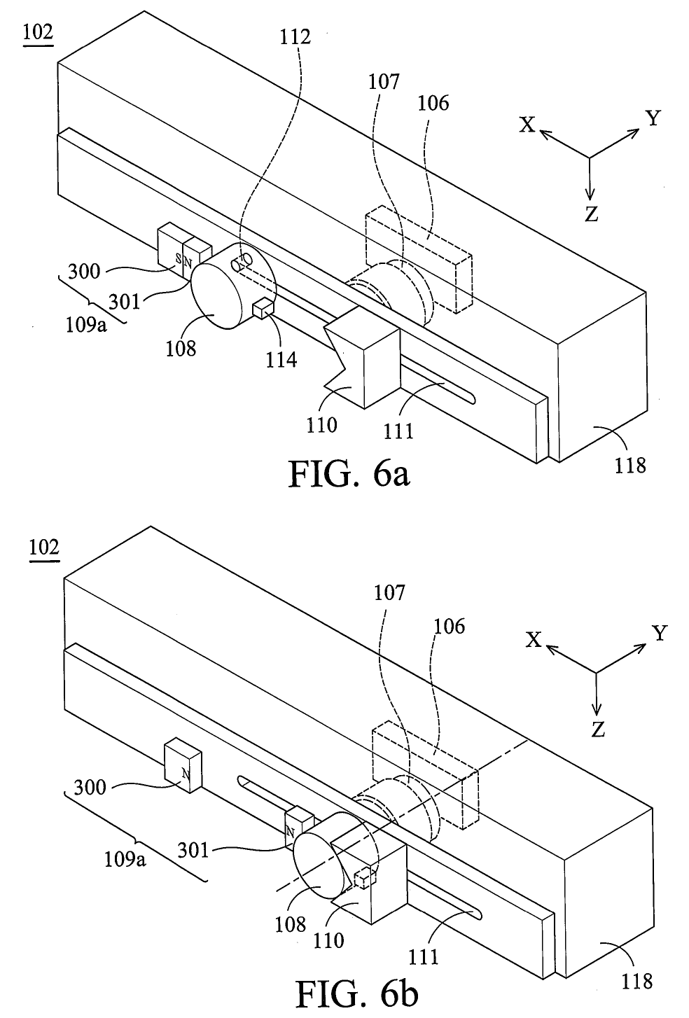

FIG. 6a is a perspective diagram of the scan module 102 when the second lens 108 is in the first position 200 with the cover 117 removed. In this embodiment, the scan module 102 has a driving mechanism 109a including an electromagnet 300 disposed on the main body 118 and a magnet 301 fixed to the second lens 108. The second lens 108 is moved along the rail 111 by magnetic attraction or repulsion between the electromagnet 300 and the magnet 301.

When the electromagnet 300 produces a first magnetic polarity to attract the magnet 301, the second lens 108 is moved with the magnet 301 to the first position 200, as shown in FIG. 6a. When the electromagnet 300 produces a second magnetic polarity to repulse the magnet 301, as shown in FIG. 6b, the second lens 108 is moved with the magnet 301 from the first position 200 to the second position 201.

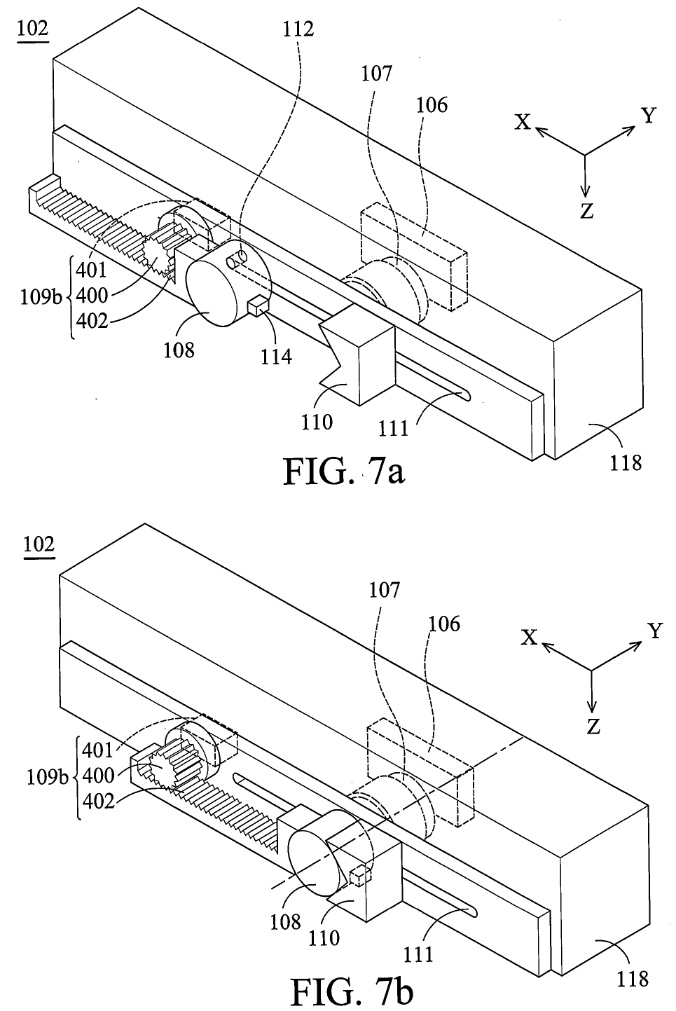

Referring to FIGS. 7a and 7b, another embodiment of a driving mechanism 109b primarily includes a gear 400, a motor 401 disposed in the main body 118, and a rack 402 fixed to the second lens 108. In this embodiment, the gear 400 is connected to the motor 401 and engaged with the rack 402. When the motor 401 rotates the gear 400, the rack 402 is driven to move the second lens 108 between the first and second positions 200 and 201 along the rail 111.

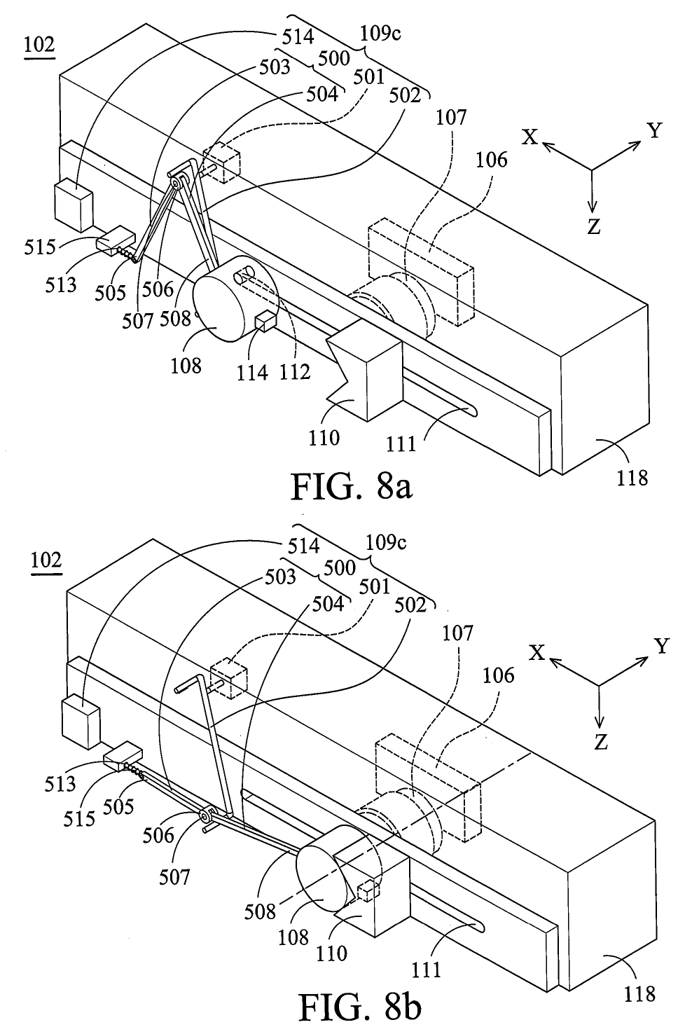

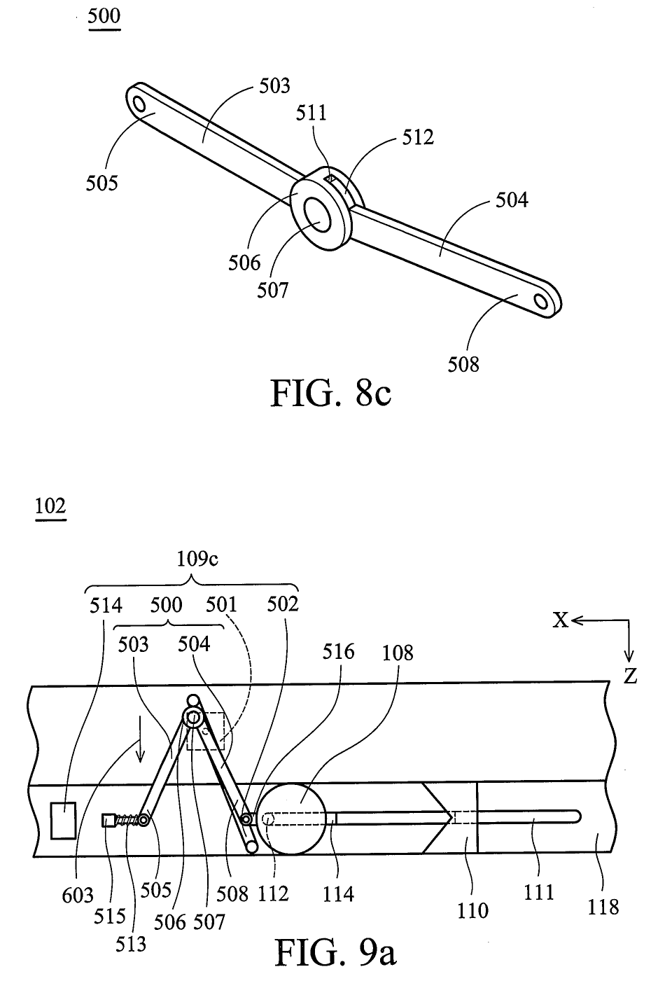

Referring to FIGS. 8a and 8b, another embodiment of a driving mechanism 109c primarily includes a linkage structure 500, a motor 501, a lever 502, and a magnetic element 514. The linkage structure 500 includes a first rod 503 and a second rod 504 pivotally connected to each other. The first rod 503 has a first end 505 and a second end 506, and the second rod 504 has a third end 507 and a fourth end 508.

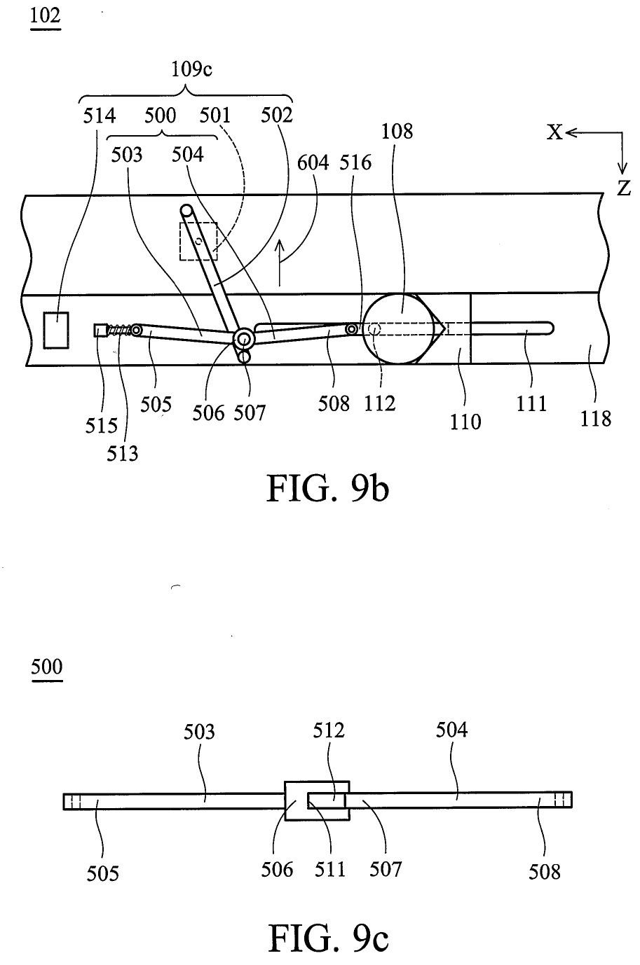

As shown in FIGS. 8a and 8b, the main body 118 of the carrier 105 has a longitudinal projecting support portion 515, and the first end 505 is pivotally connected thereto. Furthermore, the second lens 108 has a magnetic connection portion 516 pivotally connected to the fourth end 508, as shown in FIGS. 9a and 9b. In this embodiment, the magnetic element 514 is fixed to the main body 118, magnetically attracting the magnetic connection portion 516.

Referring to FIG. 8c, the second end 506 has a first joining portion 511, such as a slot, and the third end 507 has a second joining portion 512, such as a tab rotatably received in the slot. When the second lens 108 moves to the second position, as shown in FIGS. 8b and 9b, a spring 513 around the support portion 515 continuously pushes against the first end 505, to retain the second lens 108 in the second position 201.

When the linkage structure 500 is in a first state, as shown in FIG. 8a, the linkage structure 500 forms a V-shaped structure, such that the second lens 108 is in the first position 200. When the linkage structure 500 moves from the first state to a second state, as shown in FIG. 8b, the linkage structure 500 is unfolded and impels the second lens 108 to the second position 201, such that the first and second rods 503 and 504 have an angle approximately 170°. Here, the motor 501 is disposed in the main body 118 of the carrier 105 and connected to the lever 502 for switching the linkage structure 500 between the first state (FIG. 9a) and second states (FIG. 9b).

Referring to FIG. 9a, when the linkage structure 500 is in the first state, the second lens 108 is held in the first position 200 by magnetic attraction between the magnetic connection portion 516 and the magnetic element 514. When switching the linkage structure 500 from the first state to the second state, the motor 501 impels the lever 502 along the direction 603, as shown in FIG. 9a. Subsequently, the lever 502 pushes against the joint between the second and third ends 506 and 507, such that the linkage structure 500 is unfolded to the second state.

When the linkage structure 500 moves to the second state, as shown in FIG. 9b, the spring 513 continuously exerts a spring force on the first end 505 to retain the second lens 108 in the second position 201. Furthermore, when the linkage structure 500 moves to the second state, the first joining portion 511 is joined with the second joining portion 512, as shown in FIG. 9c, enhancing stability and positioning accuracy of the second lens 108. In this embodiment, the first and second rods 503 and 504 form an angle approximately 170° when the linkage structure 500 is in the second state.

When returning the linkage structure 500 from the second state to the first state, the motor 501 impels the lever 502 along the direction 604, as shown in FIG. 9b. Subsequently, the lever 502 pull the joint between the second and third ends 506 and 507, such that the linkage structure 500 returns to the first state as shown in FIG. 9a. Since the linkage structure 500 is movable between the first and second states by the driving mechanism 109c, the second lens 108 can be alternatively switched between the first and second positions 200 and 201 for scanning regular or small objects.

The invention provides a scan module including a first lens and a movable second lens for scanning regular or small objects. Different driving mechanisms for moving the second lens are disclosed according to the embodiments. When scanning a regular object, the primary lens is applied. When scanning a small object, the second lens is optically incorporated with the first lens, facilitating efficient pixel utilization and high resolution.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scan module, comprising:
a carrier;
a first lens fixed to the carrier;
an optical sensor fixed to the carrier, detecting light from a scan area through the first lens to the optical sensor along an optical path; and
a second lens, movably connected to the carrier, wherein the second lens is out of the optical path when in a first position, and the second lens intervenes and alters the optical path when in a second position.

2. The scan module as claimed in claim 1, wherein the optical sensor comprises a CCD.

3. The scan module as claimed in claim 1, wherein the first and second lenses are centrally aligned with each other when the second lens in the second position.

4. The scan module as claimed in claim 1, wherein when the second lens is in the second position, the first lens is located between the second lens and the optical sensor.

5. The scan module as claimed in claim 1, further comprising a positioning block fixed to the carrier, to retain the second lens in the second position.

6. The scan module as claimed in claim 5, wherein the positioning block has a recess with the second lens joined thereto when in the second position.

7. The scan module as claimed in claim 6, wherein the second lens has a nub joining to the recess when the second lens is in the second position.

8. The scan module as claimed in claim 1, wherein the carrier comprises a rail and the second lens comprises a slider moving along the rail.

9. The scan module as claimed in claim 1, further comprising a driving mechanism impelling the second lens between the first and second positions.

10. The scan module as claimed in claim 9, the driving mechanism comprising an electromagnet fixed to the carrier and a magnet fixed to the second lens, wherein the second lens is moved between the first and second positions by magnetic attraction or repulsion between the electromagnet and the magnet.

11. The scan module as claimed in claim 9, the driving mechanism comprising a gear, a motor connected to the gear, and a rack fixed to the second lens and engaged with the gear, wherein the motor rotates the gear to impel the rack and the second lens between the first and second positions.

12. The scan module as claimed in claim 9, the driving mechanism comprising:
a linkage structure, including a first rod, a second rod, the first rod having a first end and a second end, the second rod having a third end and a fourth end, wherein the first end is pivotally connected to the carrier, the second end is pivotally connected to the third end, and the fourth end is pivotally connected to the second lens; and
a lever, impelling the linkage structure between a first state and a second state, wherein the second lens is in a first position when the linkage structure moves to the first state, and the second lens is in a second position when the linkage structure moves to the second state.

13. The scan module as claimed in claim 12, wherein the driving mechanism further comprises a motor connected to the carrier and the level, to impel the linkage structure via the lever.

14. The scan module as claimed in claim 12, wherein the level exerts a force on a joint between the second and third ends.

15. The scan module as claimed in claim 12, wherein the first and second rods form a V-shaped structure when in the first state.

16. The scan module as claimed in claim 12, wherein the first and second rods substantially have an angle of 170° when in the second state.

17. The scan module as claimed in claim 12, wherein the first rod has a first joining portion, and the second rod has a second joining portion joined with the first joining portion.

18. The scan module as claimed in claim 17, wherein the first joining portion comprises a slot, and the second joining portion comprises a tab corresponding to the slot.

19. The scan module as claimed in claim 12, wherein the carrier comprises a support portion pivotally connected to the first end, and the second lens comprises a connection portion pivotally connected to the fourth end.

20. The scan module as claimed hi claim 19, wherein the support portion has a longitudinal projecting structure.

21. The scan module as claimed in claim 19, further comprising a spring disposed around the support portion, wherein the spring exerts a spring force on the first end to retain the second lens in the second position.

22. The scan module as claimed in claim 19, wherein the driving mechanism further comprising a magnetic element fixed to the carrier, and wherein the connection portion is magnetic, the second lens is held in the first position by magnetic attraction from the magnetic element and the connection portion when the linkage structure is in the first state.

23. A scanner, comprising:
a housing, comprising a transparent plate with an object disposed thereon;
a scan module as claimed in claim 1, movably disposed in the housing to scan the object within the scan area.

24. A method of scanning an object, comprising:
providing an optical system having a first lens, a second lens and an optical sensor, wherein the second lens is moveable between a first position and a second position;
disposing the object in a scan area, wherein the optical sensor, the first lens and the scan area define an optical path; and
moving the second lens from the first position to the second position, wherein the second lens intervenes and alters the optical path when in the second position.

25. The method as claimed in claim 24, wherein the optical system has a first focal length when the second lens is in the first position, and the optical system has a second focal length when the second lens is in the second position.

26. The method as claimed in claim 25, wherein the second focal length exceeds the first focal length.

27. The method as claimed in claim 24, further comprising acquiring an image of the object by the optical sensor.
